(19) United States
(12) Patent Application Publication
(10) Pub. No.: US 2025/0102972 A1
(43) Pub. Date: Mar. 27, 2025

(54) FIXING DEVICE AND IMAGE FORMING APPARATUS

(71) Applicant: FUJIFILM Business Innovation Corp., Tokyo (JP)

(72) Inventors: Takashi MATSUBARA, Kanagawa (JP); Takashi Ohashi, Kanagawa (JP); Takuma Ishihara, Kanagawa (JP); Hina Saito, Kanagawa (JP); Sodai Higuchi, Kanagawa (JP)

(73) Assignee: FUJIFILM Business Innovation Corp., Tokyo (JP)

(21) Appl. No.: 18/586,705

(22) Filed: Feb. 26, 2024

(30) Foreign Application Priority Data
Sep. 27, 2023 (JP) 2023-164225

(51) Int. Cl. G03G 15/20

(52) U.S. Cl. CPC G03G 15/2028; G03G 15/2025; G03G 2215/2032

(57) ABSTRACT

A fixing device includes: a fixing belt; plural holding members that hold the fixing belt so that the fixing belt is rotatable; a pressing roller that presses the fixing belt against one of the plural holding members from an outer peripheral surface of the fixing belt so as to form a fixing processing portion; an applicator that applies oil to an inner peripheral surface of the fixing belt; and a first guide member that is provided for at least one holding member of the plural holding members and includes a guiding surface with which a side of the fixing belt is brought into contact, the guiding surface being formed as a slope tilting toward an outer side of a longitudinal direction of the at least one holding member.

### CROSS-REFERENCE TO RELATED APPLICATIONS

This application is based on and claims priority under 35 USC 119 from Japanese Patent Application No. 2023-164225 filed Sep. 27, 2023.

### BACKGROUND

### (i) Technical Field

The present disclosure relates to a fixing device and an image forming apparatus.

### (ii) Related Art

Japanese Unexamined Patent Application Publication No. 2005-266376 discloses a fixing device including a fixing belt, a heating unit, a pressurizing roller, a pressing member, a guide member, a driving roller, and a driving belt.

This publication describes that the guide member abuts against the inner peripheral surface of side portions of the fixing belt to guide the rotation movement of the fixing belt and that the driving belt transmits a driving force of the driving roller to the fixing belt.

Japanese Unexamined Patent Application Publication No. 2004-286923 discloses a fixing device including a fixing belt, a pressurizing roller, and a nip forming member. The fixing belt is stretched above a heating member and the nip forming member.

This publication describes that a projection for restricting the meandering of the fixing belt is formed on both sides of the nip forming member in the longitudinal direction, integrally with the nip forming member.

Japanese Unexamined Patent Application Publication No. H11-91978 discloses a fixing device including a fixing belt, a belt positional-deviation detecting member, a support unit, and a belt driving unit. The fixing belt is stretched at least between a driving roller and a driven roller.

This publication describes that the belt positional-deviation detecting member is rotatably supported independently of the driven roller, the support unit supports an end portion of a shaft of the driven roller perpendicularly to the direction of the shaft, and the belt driving unit includes a converter that converts a displacement of the end portion of the shaft of the driven roller into a displacement in a predetermined direction, which is a direction perpendicular to the direction of the shaft.

This publication also describes that the support unit includes a shaft-end-portion support member, a belt urging member, and a guide member. The guide member guides the shaft-end-portion support member to a predetermined direction and the fixing belt to its stretching direction.

### SUMMARY

Aspects of non-limiting embodiments of the present disclosure relate to a fixing device that applies oil to an inner peripheral surface of a fixing belt and also corrects the meandering of the fixing belt by bringing a side portion of the fixing belt into contact with a guiding surface of a guide member and that makes it less likely to cause a leakage of the oil applied to the inner peripheral surface to an outer peripheral surface of the fixing belt, which occurs when the fixing belt passes by the guide member, than a configuration in which the guiding surface of the guide member is formed as a vertical surface along the thickness direction of the fixing belt.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided a fixing device including: a fixing belt; plural holding members that hold the fixing belt so that the fixing belt is rotatable; a pressing roller that presses the fixing belt against one of the plural holding members from an outer peripheral surface of the fixing belt so as to form a fixing processing portion; an applicator that applies oil to an inner peripheral surface of the fixing belt; and a first guide member that is provided for at least one holding member of the plural holding members and includes a guiding surface with which a side of the fixing belt is brought into contact, the guiding surface being formed as a slope tilting toward an outer side of a longitudinal direction of the at least one holding member.

### BRIEF DESCRIPTION OF THE DRAWINGS

Exemplary embodiments of the present disclosure will be described in detail based on the following figures, wherein:

FIG. 1 is a schematic view of an image forming apparatus according to a first exemplary embodiment;

FIG. 2 is a schematic view of a fixing device according to the first exemplary embodiment;

FIG. 3A is a schematic side view of a steering roller and guide members in the fixing device shown in FIG. 2;

FIG. 3B is an enlarged view of one of the guide members in the steering roller shown in FIG. 3A;

FIG. 4A is a conceptual view illustrating the relationships between the components of the fixing device shown in FIG. 2;

FIG. 4B is an enlarged view illustrating a state in which the steering roller and one of the guide members shown in FIGS. 3A and 3B are holding a fixing belt;

FIG. 5A is a conceptual view illustrating a state in which the fixing belt is meandering in the fixing device shown in FIGS. 4A and 4B;

FIG. 5B is an enlarged view illustrating a state in which the steering roller and one of the guide members tilted due to the meandering of the fixing belt are holding the fixing belt;

FIG. 6 is a schematic view of a fixing device according to a second exemplary embodiment;

FIG. 7 is a conceptual view illustrating the relationships between the components of the fixing device shown in FIG. 6;

FIG. 8 is a conceptual view illustrating a state in which the fixing belt is meandering in the fixing device shown in FIG. 6;

FIG. 9 is an enlarged view illustrating a state in which individual holding members and one of guide members of each of the holding members in the fixing device shown in FIG. 8 are holding a fixing belt;

FIG. 10A is an enlarged view of a modified example of a guiding surface of a guide member;

FIG. 10B is an enlarged view illustrating a state in which a steering roller provided with the guide member shown in FIG. 10A is holding a fixing belt;

FIG. 11A is a schematic side view of a steering roller and a guide member of a comparative example in a fixing device;

FIG. 11B is a schematic side view illustrating a state in which the steering roller and the guide member of the comparative example shown in FIG. 11A start operating in response to the meandering of a fixing belt; and

FIG. 12 is a schematic view illustrating a leakage of oil to the outer peripheral surface of a fixing belt, which occurs when the fixing belt passes by the steering roller and the guide member of the comparative example shown in FIGS. 11A and 11B.

### DETAILED DESCRIPTION

Exemplary embodiments of the disclosure will be described below.

### First Exemplary Embodiment

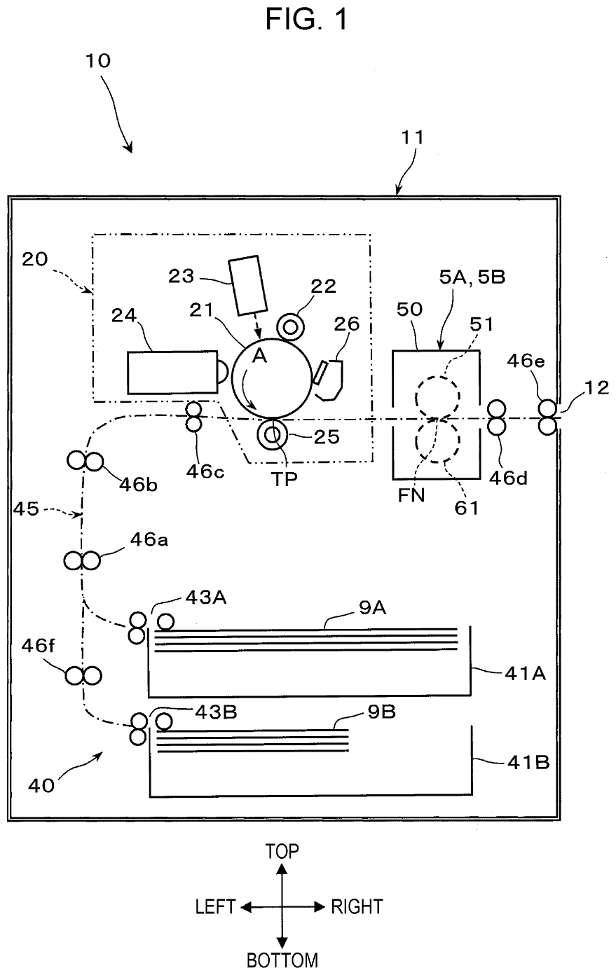

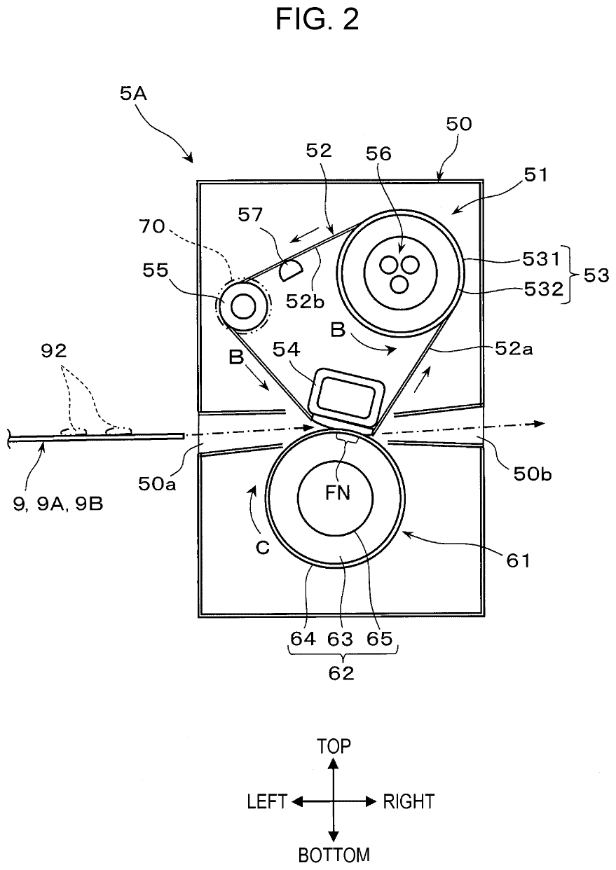

FIG. 1 illustrates an image forming apparatus 10 according to a first exemplary embodiment of the disclosure. FIG. 2 illustrates a fixing device 5A according to the first exemplary embodiment.

In the specification and the drawings, elements substantially identical to each other are designated by like reference numeral and an explanation thereof will not be repeated. To facilitate the easy understanding of the drawings, elements that are not necessary for a description of the disclosure are not shown.

### (1) Configuration of Image Forming Apparatus

The image forming apparatus 10 forms an image, which is not yet fixed, corresponding to image information input from an external source on a sheet 9, which is an example of a recording medium.

As illustrated in FIG. 1, the image forming apparatus 10 includes a housing 11 having a desired external shape. The image forming apparatus 10 includes, within the internal space of the housing 11, an image forming unit 20, a sheet supply unit 40, a sheet transport unit 45, and a fixing device 5A, for example.

The long dashed dotted line in FIG. 1 indicates a major transport path through which a sheet 9 is transported within the housing 11 by the sheet transport unit 45.

The image forming unit 20 forms a toner image made of a toner, which is a developer, and transfers the formed toner image to a sheet 9.

In the first exemplary embodiment, the image forming unit 20 is formed as an image forming unit based on an electrophotographic system. The image forming unit 20 includes various devices, such as a photoconductor drum 21, a charger 22, an exposure device 23, a developing device 24, a transfer device 25, and a cleaner 26.

The photoconductor drum 21, which is an example of an image holding unit, is a drum-shaped photoconductor having a photosensitive layer, which serves as an image forming plane or an image holding plane. The photoconductor drum 21 rotates in a direction indicated by the arrow A in FIG. 1 upon receiving power from a driver, which is not shown.

The charger 22 charges the outer peripheral surface (image forming plane) of the photoconductor drum 21 to a required surface potential. As the charger 22, a device including a charging member having a roller shape, for example, may be used. The charging member is brought into contact with the image forming plane on the outer peripheral surface of the photoconductor drum 21 and also receives a charging current.

The exposure device 23 applies light corresponding to image information to the charged outer peripheral surface of the photoconductor drum 21 so as to form an electrostatic latent image on the outer peripheral surface of the photoconductor drum 21. The exposure device 23 starts driving upon receiving an image signal generated as a result of image information input from an external source being subjected to predetermined processing by an image processor (not shown) or another device. The image information is information related to an image, such as text, a figure, a photo, and a pattern, for example.

The developing device 24 develops the electrostatic latent image formed on the outer peripheral surface of the photoconductor drum 21 by using a developer (toner) of a corresponding color (black, for example) so as to visualize the electrostatic latent image as a toner image of the predetermined color. As the developer, a two-component developer including toner and a carrier, for example, is used.

The transfer device 25 transfers a toner image, which is not yet fixed, formed on the outer peripheral surface of the photoconductor drum 21 to a sheet 9. As the transfer device 25, a device including a transfer member having a roller shape, for example, may be used. The transfer member is brought into contact with the outer peripheral surface of the photoconductor drum 21 and also receives a transfer current.

The position at which the transfer device 25 and the photoconductor drum 21 face each other is a transfer position TP at which a toner image, which is not yet fixed, is transferred to a sheet 9.

The cleaner 26 cleans the outer peripheral surface of the photoconductor drum 21 by removing unwanted matter, such as unwanted toner and dust, attached to the outer peripheral surface of the photoconductor drum 21.

The sheet supply unit 40 stores sheets 9 to be supplied to the transfer position TP in the image forming unit 20 and feeds each sheet 9 at a predetermined timing.

The sheet supply unit 40 includes components, such as a storage 41 for storing sheets 9 therein and a feeder 43 that feeds sheets 9 one by one.

In the first exemplary embodiment, as the storage 41, two storages 41A and 41B are provided, and as the feeder 43, two feeders 43A and 43B are provided. Sheets 9A are stored in the storage 41A, while sheets 9B are stored in the storage 41B. The size of the sheets 9A and that of the sheets 9B are different from each other, for example.

The sheets 9 are not limited to a particular material and form if they are a sheet-like recording medium which can be transported within the housing 11 and to which unfixed toner images can be transferred and fixed.

In the image forming apparatus 10, as the sheets 9, recording mediums, such as plain paper, coated paper, film, and cardboard cut into a predetermined size, and recording mediums, such as envelopes, may be used.

The sheet transport unit 45 transports a sheet 9 to a certain location within the housing 11.

The sheet transport unit 45 includes various paths, such as a supply path, a relay path, and a discharge path. The supply path is a path through which a sheet 9 is transported from the sheet supply unit 40 to the transfer position TP in the image forming unit 20. The relay path is a path through which a sheet 9 is transported from the transfer position TP in the image forming unit 20 to the fixing device 5A. The discharge path is a path through which a sheet 9 is transported from the fixing device 5A to a discharge outlet 12 provided on a certain location, such as a side surface, of the housing 11.

The sheet transport unit 45 also includes a combination of components, such as multiple transport roller pairs 46 and a transport path member, which is not shown. The transport roller pair 46 is a pair of transport rollers that transport a sheet 9 while holding the sheet 9 therebetween. In the first exemplary embodiment, six transport roller pairs 46a through 46f, for example, are used. The transport path member is a member that forms a transport space, for example, for a sheet 9 so as to guide the sheet 9 to a transport destination.

The fixing device 5A fixes an image, which is not yet fixed, onto a sheet 9. The image, which is not yet fixed, is a toner image formed in the image forming unit 20 and transferred to the sheet 9.

As illustrated in FIGS. 1 and 2, the fixing device 5A according to the first exemplary embodiment includes components, such as a heating rotator 51 and a pressurizing rotator 61, within the internal space of a casing 50.

The casing 50 includes an inlet 50a into which a sheet 9 is input and an outlet 50b from which a fixed sheet 9 is output.

In the fixing device 5A, the heating rotator 51 and the pressurizing rotator 61 are brought into contact with each other and rotate together, and a portion at which the heating rotator 51 and the pressurizing rotator 61 contact each other is formed as a fixing processing portion FN. The fixing processing portion FN is a portion that performs fixing processing by applying heat and pressure to a sheet 9 and a toner image thereon which pass through this portion. The fixing processing portion FN is also called a fixing nip.

Details of the fixing device 5A will be discussed later.

### (2) Operation of Image Forming Apparatus

The image forming apparatus 10 performs a basic image forming operation in the following manner.

In the image forming apparatus 10, in response to a controller, which is not shown, receiving an instruction to form an image, the image forming unit 20 performs a charging operation, exposure operation, developing operation, and transfer operation. In the image forming apparatus 10, the sheet supply unit 40 and the sheet transport unit 45 perform a sheet feeding operation.

With the above-described operations, in the image forming unit 20, a toner image corresponding to image information is formed on the image forming plane of the photoconductor drum 21 rotating in the direction indicated by the arrow A in FIG. 1. Meanwhile, a certain sheet 9 (9A or 9B) is fed from the sheet supply unit 40 and is supplied to the transfer position TP in the image forming unit 20 via the supply path of the sheet transport unit 45.

In the image forming unit 20, the toner image is transferred from the photoconductor drum 21 to the sheet 9 (9A or 9B) at the transfer position TP.

In the image forming unit 20, the cleaner 26 performs cleaning while the photoconductor drum 21 is rotating.

As a result, the image forming plane of the photoconductor drum 21 is cleaned by the cleaner 26 at a certain timing, such as after a toner image is transferred.

Then, in the image forming apparatus 10, the sheet 9 having the toner image transferred thereon is transported to the fixing device 5A via the relay path in the sheet transport unit 45. In the relay path, the sheet 9 is fed in a state in which it is sandwiched between the rotating photoconductor drum 21 and the transfer device 25.

As shown in FIG. 2, the fixing device 5A performs a fixing operation so that the sheet 9 (9A or 9B) having a toner image 92 transferred thereon is subjected to fixing processing in the fixing processing portion FN.

With the fixing operation of the fixing device 5A, when the toner image 92, which is not yet fixed, formed on the sheet 9 is input into the fixing processing portion FN and passes through it, it is heated under pressure and is fixed onto the sheet 9.

Subsequently, in the image forming apparatus 10, the sheet 9 having the toner image 9 fixed thereon is output from the casing 50 of the fixing device 5A and is transported to the discharge outlet 12 via the discharge path in the sheet transport unit 45.

The sheet 9 is then fed by the transport roller pair 46e to an output sheet storage, which is not shown, provided on part of the housing 11 and is stored in the output sheet storage.

As a result of the above-described series of operations, the basic image forming operation is completed to form a single color image on one side of one sheet 9.

### (3-1) Configuration of Fixing Device

The fixing device 5A will be explained in detail.

As shown in FIG. 2, the fixing device 5A uses a heating unit in the form of a belt and a nip as the heating rotator 51 and also uses a pressurizing roller 62 as the pressurizing rotator 61. The pressurizing roller 62 is an example of a pressing roller.

The heating rotator 51 includes a fixing belt 52, three holding members 53, 54, and 55, and an oil application device 57, for example. The holding members 53, 54, and 55 hold the fixing belt 52 so that the fixing belt 52 is rotatable.

More specifically, the holding members 53, 54, and 55 are a heating roller 53, a contact member 54, and a steering roller 55. The fixing belt 52 is held to be rotatable in the direction indicated by B (counterclockwise in FIG. 2).

The fixing belt 52 is an endless belt whose outer peripheral surface 52a is brought into contact with the surface of the sheet 9 having the toner image 92 transferred thereon at the fixing processing portion FN so as to fix the toner image 92 onto the sheet 9.

As the fixing belt 52, an endless belt having thermal conductivity, flexibility, and heat resistance is used. As the fixing belt 52, the following multilayer belt, for example, may be used. The multilayer belt is constituted by an elastic layer and a release layer formed on the outer peripheral surface of a tubular belt base member in this order.

As the belt base member, a tubular member made of synthetic resin, such as polyimide or polyamide, is used. As the elastic layer, a layer made of an elastic material, such as silicone rubber, is formed. As the release layer, a layer made of a resin material, such as polytetrafluoroethylene, is formed.

The heating roller 53 is an example of a rotator roller including a heater 56. The heating roller 53 is a rotator roller that is heated by the heater 56 and that also heats the fixing belt 52.

As the heating roller 53, a roller constituted by a cylindrical roller base member 531 and a surface layer 532 disposed on the outer peripheral surface of the roller base member 531 is used.

The roller base member 531 is a cylindrical body made of a metal material, such as aluminum. The roller base member 531 is rotatably mounted on part of the casing 50 via a bearing, which is not shown. The surface layer 532 is a nonconductive, high thermal conductive layer.

As the heater 56, multiple electric heat lamps disposed in the internal space of the roller base member 531, for example, are used.

The contact member 54 is brought into contact with an inner peripheral surface 52b of the fixing belt 52 at a certain position so as to hold the fixing belt 52.

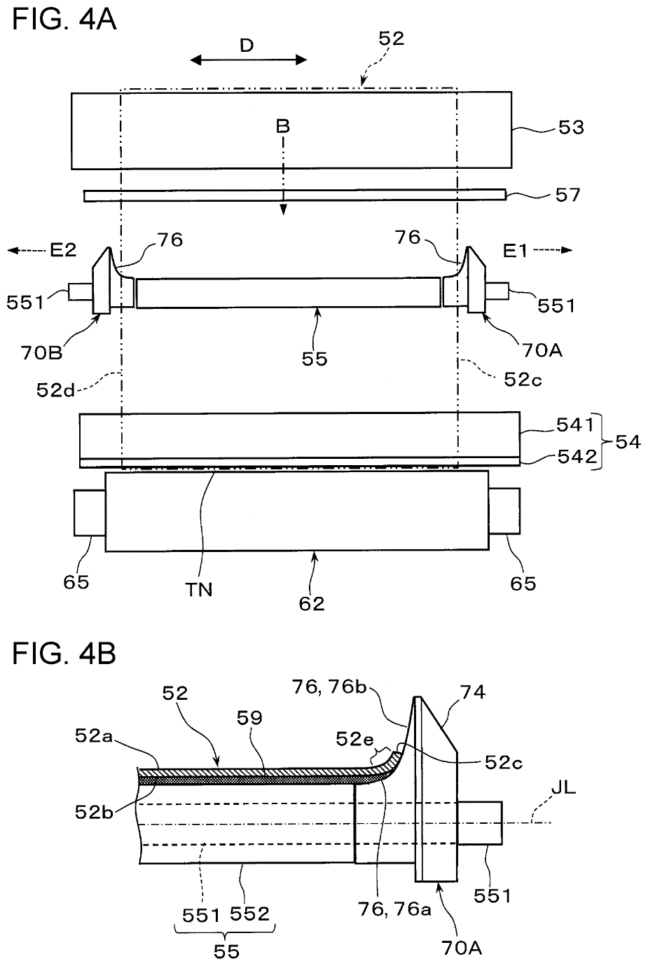

As the contact member 54, a structure in which a pad 542 is disposed on the bottom surface of a tubular supporter 541 is used, as shown in FIG. 4A and other drawings.

The supporter 541 is a structure made of a metal material, such as aluminum. The supporter 541 is mounted on part of the casing 50. The pad 542 is a member having properties, such as heat resistance and elasticity.

The contact member 54 includes a sliding sheet, which is not shown, intervening between the outer surface of the pad 542 and the inner peripheral surface 52b of the fixing belt 52. One end of the sliding sheet is attached to the supporter 541.

The contact member 54 is raised at a corner on the side on which a sheet 9 to be fixed is input (on the left side in FIG. 2) and is disposed in a state in which it slightly leans backward as a whole.

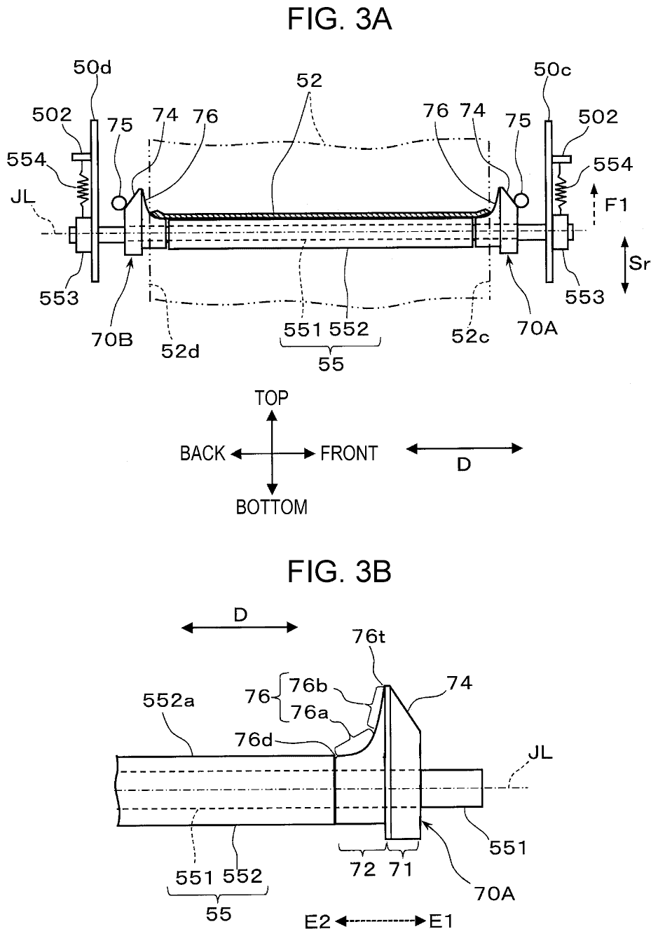

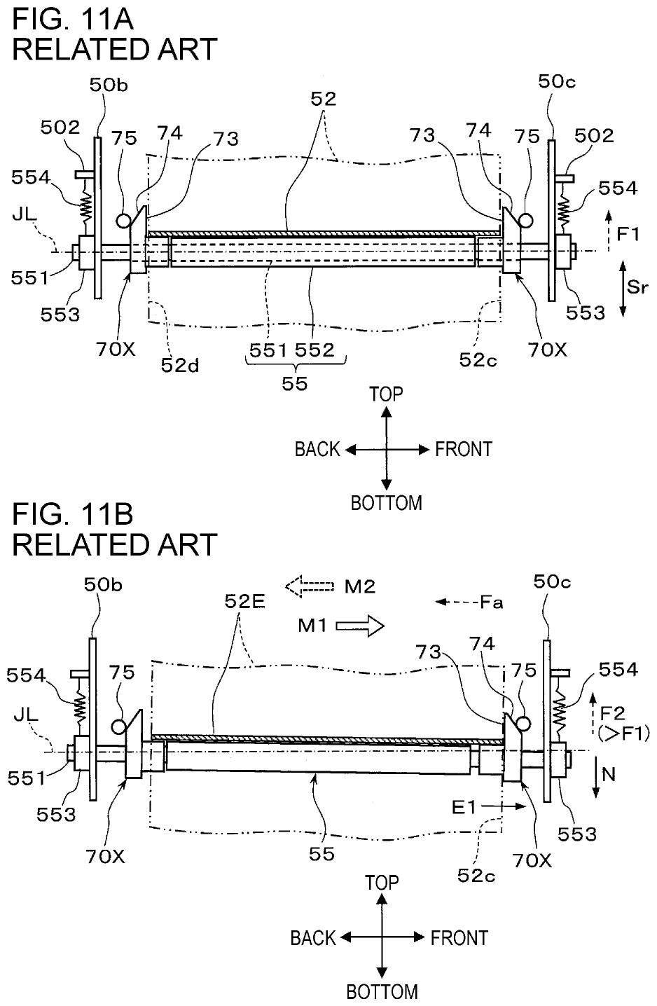

As illustrated in FIGS. 3A, 11A, and 11B, the steering roller 55 is a roller that stops meandering of the fixing belt 52 as a result of a rotating shaft 551 of the steering roller 55 being tilted in response to the meandering of the fixing belt 52 and then returning to the original position. Hence, the steering roller 55 can also be called a meandering correction roller.

As shown in FIG. 3A, in the first exemplary embodiment, the steering roller 55 includes the rotating shaft 551, a roller body 552 secured to the rotating shaft 551, and first guide members 70A and 70B provided at portions of the rotating shaft 551 adjacent to both ends of the roller body 552.

The rotating shaft 551 is rotatably supported at both ends by bearings 553. The bearings 553 are fitted to elongated holes, which are not shown, provided on a front surface 50c and a back surface 50d of the casing 50 so that they are movable by a predetermined distance substantially in the top-down direction Sr.

With this configuration, the rotating shaft 551 is also movable in the elongated holes via the bearings 553 by a predetermined distance substantially in the top-down direction Sr.

The bearings 553 are pulled upward by extension springs 554 with a certain spring force F1. The top ends of the extension springs 554 are secured to mounting portions 502 provided on the front surface 50c and the back surface 50d of the casing 50.

With this configuration, the rotating shaft 551 is maintained in a state in which it is pulled upward by the extension springs 554 via the bearings 553 with the certain force F1. Basically, the rotating shaft 551 is maintained in a state in which the bearings 553 contact the top ends of the elongated holes, which are not shown.

The roller body 552 is a roller which holds the inner portion of the fixing belt 52 except for side portions including sides 52c and 52d. The roller body 552 is secured to the rotating shaft 551 and is rotated together with the rotating shaft 551.

The first guide members 70A and 70B are provided on the portions of the rotating shaft 551 adjacent to both ends of the roller body 552 so that they are rotatable and movable in the axial direction.

Details of the steering roller 55 and the first guide members 70A and 70B will be discussed later.

The oil application device 57, which is an example of an oil applicator, applies oil to the inner peripheral surface 52b of the fixing belt 52.

The purpose of applying oil to the fixing belt 52 is to ease sliding resistance between the inner peripheral surface 52b of the fixing belt 52 and the contact member 54 and to remove wear debris on the inner peripheral surface 52b.

As the oil application device 57, an oil applicator constituted by an impregnator member impregnated with oil and a holding member, for example, is used.

The holding member holds the impregnator member so that the impregnator member contacts the inner peripheral surface 52b of the fixing belt 52. As the oil, silicone oil, for example, is used.

The oil application device 57 is located to apply oil to a portion of the inner peripheral surface 52b of the fixing belt 52 between the heating roller 53 and the steering roller 55. The oil application device 57 applies oil to the entire widthwise direction of the inner peripheral surface 52b of the fixing belt 52, which is the direction perpendicular to the rotation direction B.

The pressurizing roller 62, which serves as the pressurizing rotator 61, is a roller that forms the fixing processing portion FN by pressing the outer peripheral surface 52a of the fixing belt 52 against the contact member 54.

As shown in FIG. 2, the pressurizing roller 62 is formed as a roller structure in which an elastic release layer 64 is disposed on the outer peripheral surface of a cylindrical or tubular roller base member 63. A shaft member 65 shown in FIG. 2 and other drawings is provided at both ends of the roller base member 63.

The pressurizing roller 62 is supported by a support structure, which is not shown, so as to be displaced in a direction in which the shaft member 65 is close to and away from the contact member 54.

At least during the fixing operation, a predetermined pressure is applied to the shaft member 65 of the pressurizing roller 62 by a pressurizing mechanism, which is not shown, so as to press the pressurizing roller 62 against the contact member 54.

Additionally, at a certain timing, such as at the start of the fixing operation, the pressurizing roller 62 starts rotating in the direction indicated by the arrow C in FIG. 2 upon receiving power from a driver, which is not shown.

In the fixing device 5A, as a result of the pressurizing roller 62 rotating in the direction indicated by the arrow C, the fixing belt 52 is rotated in the direction indicated by the arrow B. In the fixing device 5A, at a certain timing, the heating roller 53 may start rotating in the direction indicated by the arrow B upon receiving power from a driver, which is not shown.

### (3-2) Configuration of Guide Member of Comparative Example

Before explaining the first guide members 70A and 70B of the steering roller 55 in the first exemplary embodiment, a first guide member 70X of a comparative example illustrated in FIGS. 11A and 11B will be discussed below.

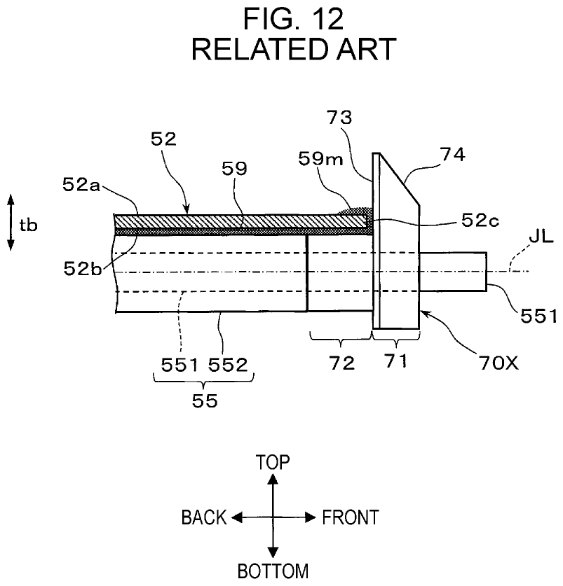

The first guide member 70X is a structure including a body 71 and a mounting portion 72, as shown in FIG. 12.

The body 71 is a portion having a semi-disc-like shape and has a guiding surface 73 and a movement leading surface 74.

The mounting portion 72 is a portion for mounting the first guide member 70X on a rotating shaft 551 so that the first guide member 70X is rotatable and movable by a predetermined distance in the axial direction.

The guiding surface 73 of the body 71 of each of the first guide members 70X is a surface for guiding the fixing belt 52 by bringing the corresponding one of the sides 52c and 52d of the fixing belt 52 into contact with the guiding surface 73. The guiding surface 73 is formed at the inner portion of the body 71 which faces the roller body 552.

The guiding surface 73 of the first guide member 70X is formed as a vertical plane surface along a thickness direction tb (see FIG. 12) of the fixing belt 52. The thickness direction tb is a direction of the thickness of the portion of the fixing belt 52 which is supported by the steering roller 55.

It can also be said that the guiding surface 73 is formed as a plane surface perpendicular to the direction of the axis JL (axial direction).

The movement leading surface 74 of the body 71 is a tilting surface that contacts a jig 75 to lead the movement of the first guide member 70X. The movement leading surface 74 is formed as a slope for moving the first guide member 70X downward when the first guide member 70X is displaced toward the outer side of the rotating shaft 551 in response to the meandering of the fixing belt 52.

The jig 75 is formed as a spherical or round rod. Normally, the jig 75 contacts the bottom end portion of the movement leading surface 74.

### (3-3) Operation of Steering Roller

The steering roller 55 provided with the first guide member 70X of the comparative example is operated as follows.

An explanation will be given, assuming that the fixing belt 52 meanders and is displaced frontward in the direction indicated by the arrow M1, as illustrated in FIG. 11B.

In this case, when the side 52c of a meandering fixing belt 52E is passing by the steering roller 55, it is pressed hard against the guiding surface 73 of the first guide member 70X located at the front side.

Then, the first guide member 70X is pushed by the side 52c of the meandering fixing belt 52E and shifts slightly in a direction E1 toward the outer side (front side) of the rotating shaft 551. When the first guide member 70X is displaced toward the direction E1, that is, toward the outer side of the rotating shaft 551, the movement leading surface 74 of the first guide member 70X contacts the jig 75 and moves so that the first guide member 70X is shifted downward.

At this time, in response to the first guide member 70X shifting downward, the rotating shaft 551 enters a state in which the front end is moved downward via the bearing 553 in the direction indicated by the arrow N from the normal position.

As a result, the steering roller 55 is, as a whole, in a state in which the front end tilts downward from the normal position (position of the axis JL), as illustrated in FIG. 11B.

With the steering roller 55 tilting in this manner, the extension spring 554 is pulled downward in response to the bearing 553 on the front side moving downward, so that the bearing 553 is subjected to a spring force F2 in the upward direction. The spring force F2 is stronger than the spring force F1 acting in the normal state.

Then, the tilting steering roller 55 is lifted so that the front end moving downward returns to the original position until the steering roller 55 is no longer tilted.

At this time, the first guide member 70X at the front side is also lifted as a result of the movement leading surface 74 contacting the jig 75 and shifts to the backward side of the rotating shaft 551 until it returns to the original position.

As a result, as illustrated in FIG. 11B, when the side 52c of the meandering fixing belt 52E is passing by the steering roller 55, the meandering fixing belt 52E is pushed back by the guiding surface 73 of the first guide member 70X with a certain force Fa. Then, the meandering fixing belt 52E entirely moves backward and returns to the original rotating position.

In this manner, the steering roller 55 exercises the function of stopping the meandering of the fixing belt 52.

Likewise, the meandering stop function of the steering roller 55 is also exercised when the fixing belt 52 meanders and is displaced backward in the direction indicated by the arrow M2 in FIG. 11B.

### (3-4) Defect of Guide Member of Comparative Example

The following defect may occur in a fixing device using the steering roller 55 provided with the first guide member 70X of the comparative example.

As shown in FIG. 12, after the fixing belt 52 passes by the first guide member 70X of the comparative example in the steering roller 55, a portion 59m of oil 59 applied to the fixing belt 52 may leak to the outer peripheral surface 52a of the fixing belt 52 from its side 52c while the fixing belt 52 is rotating.

A leakage of the oil 59 occurs because the portion 59m of the oil 59 moves upward from a gap between the side 52c of the fixing belt 52 and the guiding surface 73 of the first guide member 70X and partially expands to the region near the side of the outer peripheral surface 52a of the fixing belt 52.

Upon the occurrence of such a leakage of the oil 59, part of the outer peripheral surface 52a of the fixing belt 52 may be stained with oil. This may lead to a failure to properly fix a toner image onto a sheet (irregularities of a fixed image) or a slippage of the fixing belt 52, which may make the rotation of the fixing belt 52 unstable and degrade the quality of a fixed image.

As a result, in an image forming apparatus 10 including such a fixing device, the quality of a formed image may be degraded.

### (3-5) Configuration of First Guide Members in First Exemplary Embodiment

The first guide members 70A and 70B in the fixing device 5A are movably provided near both ends of the steering roller 55. In the first exemplary embodiment, the vicinities of both ends of the steering roller 55 are portions of the rotating shaft 551 adjacent to both ends of the roller body 552.

As illustrated in FIG. 3B, the first guide members 70A and 70B each include a body 71 and a mounting portion 72, similarly to the first guide member 70X of the comparative example.

The body 71 has a semi-disc-like shape and includes a guiding surface formed as a slope 76, which will be discussed later, and a movement leading surface 74.

The mounting portions 72 are portions for mounting the first guide members 70A and 70B on the rotating shaft 551 so that the first guide members 70A and 70B are rotatable and movable by a predetermined distance in directions E1 and E2 along the axial direction.

In each of the first guide members 70A and 70B, as shown in FIGS. 3A and 3B, guiding surfaces with which the sides 52c and 52d of the fixing belt 52 are brought into contact are formed as slopes 76 tilting toward the outer side of the longitudinal direction D of the steering roller 55.

In this case, the longitudinal direction D of the steering roller 55 is the axial direction of the rotating shaft 551. The outer side of the longitudinal direction D is a direction from the center of the rotating shaft 551 in the axial direction toward each side of the rotating shaft 551.

In the first exemplary embodiment, the slope 76 of the guiding surface is formed as a slope tilting in a curved shape projecting toward the outer side of the axial direction of the steering roller 55, as illustrated in FIG. 3B.

The slope 76 is largely constituted by a lower curved surface 76a and an upper curved surface 76b.

The lower curved surface 76a is a slope portion which is closer to the roller body 552 and which rises from a bottom end 76d of the slope 76 and curves at a smaller curvature. The upper curved surface 76b is a slope portion which continues from the top end of the lower curved surface 76a and which rises until a top end 76t of the slope 76 and curves at a curvature larger than that of the lower curved surface 76a.

The position of the bottom end 76d of the slope 76 is the position at which the distance of the steering roller 55 from the center of the rotating shaft 551 in the radial direction is equal to the distance of the steering roller 55 from the center of the roller body 552 to a surface 552a of the roller body 552 in the radial direction.

As seen in the axial direction of the steering roller 55, the lower curved surface 76a makes up a portion of about 2 mm or smaller of the slope 76 from the bottom end 76d of the slope 76. The upper curved surface 76b makes up the rest of the slope 76, that is, a portion of the slope 76 other than the lower curved surface 76a.

In this case, the bottom end 76d of the slope 76 is the innermost end of the slope 76 in the axial direction, while the top end 76t of the slope 76 is the outermost end of the slope 76 in the axial direction.

The upper curved surface 76b may be a slope tilting in a straight line.

(3-6) Operation of Steering Roller Provided with First Guide Members

The steering roller 55 provided with the first guide members 70A and 70B holds the fixing belt 52 in the following manner under the normal conditions without the occurrence of meandering of the fixing belt 52.

As illustrated in FIGS. 3A and 4A, the steering roller 55 holds the fixing belt 52 so that the sides 52c and 52d of the fixing belt 52 contact the lower curved surfaces 76a (see FIG. 3B) of the slopes 76 on the guiding surfaces of the first guide members 70A and 70B.

In this case, as illustrated in FIG. 4B, in each of the first guide members 70A and 70B, a portion of the fixing belt 52 including the side 52c or 52d contacts part of the lower curved surface 76a of the slope 76 and is curved slightly upward (shown as a curved side portion 52e).

At this time, the curved side portion 52e of the fixing belt 52 is subjected to a reaction force due to the curving of the fixing belt 52 and is pressed against the slope 76 on the guiding surface.

In this state, the oil 59 applied to the inner peripheral surface 52b of the fixing belt 52 is kept being trapped between the curved side portion 52e of the fixing belt 52 and the slope 76 (especially the lower curved surface 76a), for example.

Hence, in the fixing device 5A, even after the fixing belt 52 passes by the first guide members 70A and 70B of the steering roller 55, it is less likely that the oil 59 leaks to the outer peripheral surface 52a of the fixing belt 52 than in a configuration in which the guiding surface is formed as a vertical surface along the thickness direction tb of the fixing belt 52, as in the guiding surface 73 of the first guide member 70X of the comparative example (see FIG. 12).

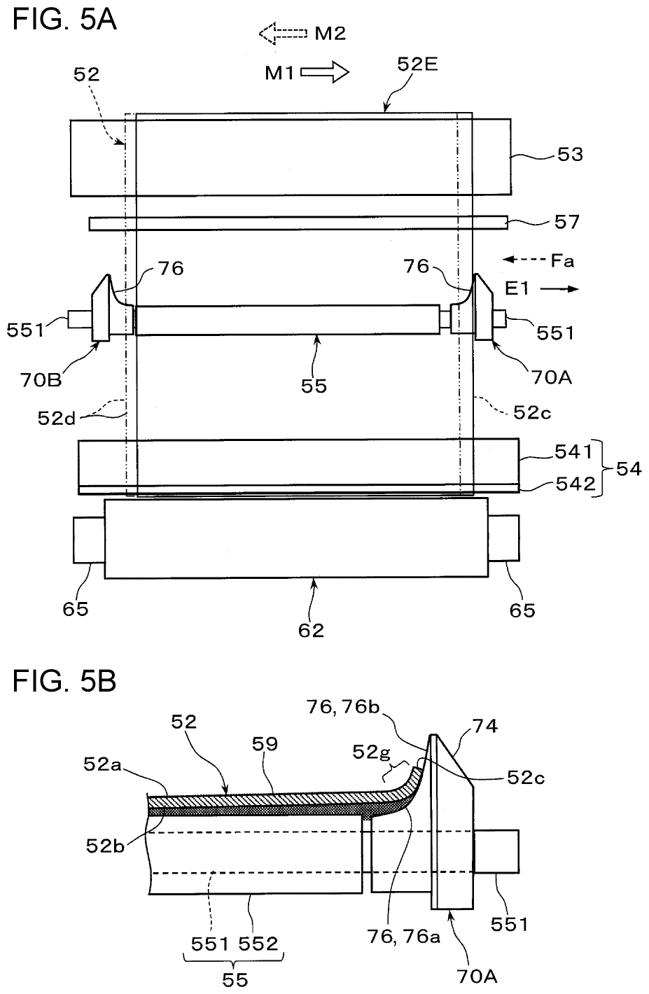

When the fixing belt 52 meanders and is displaced frontward in the direction indicated by the arrow M1 as shown in FIG. 5A, the steering roller 55 provided with the first guide members 70A and 70B is operated as follows.

The steering roller 55 provided with the first guide members 70A and 70B is operated substantially similarly to the steering roller 55 provided with the first guide members 70X of the comparative example (see FIG. 11B).

When the side 52c of a meandering fixing belt 52E is passing by the steering roller 55, it is pressed hard against the guiding surface formed as the slope 76 of the first guide member 70A located at the front side.

Then, the first guide member 70A is pushed by the side 52c of the meandering fixing belt 52E and shifts slightly in the direction E1, which is the outer side (front side) of the rotating shaft 551. When the first guide member 70A is displaced toward the outer side of the rotating shaft 551, the movement leading surface 74 of the first guide member 70A contacts the jig 75 and moves so that the first guide member 70A is shifted downward.

At this time, in response to the first guide member 70A shifting downward, the rotating shaft 551 enters a state in which the front end is moved downward via the bearing 553.

As a result, the steering roller 55 is, as a whole, in a state in which the front end tilts downward from the normal position (see FIG. 11B).

With the steering roller 55 tilting in this manner, the bearing 553 on the front side is subjected to the spring force F2 in the upward direction exerted by the extension spring 554 stretched downward (see FIG. 11B)

Then, the front end of the tilting steering roller 55 is lifted to return to the original position until the steering roller 55 is no longer tilted.

At this time, the first guide member 70A at the front side is also lifted as a result of the movement leading surface 74 contacting the jig 75 and shifts to the backward side of the rotating shaft 551 until it returns to the original position (see FIG. 3A).

As a result, as illustrated in FIG. 5A, when the side 52c of the meandering fixing belt 52E is passing by the steering roller 55, the meandering fixing belt 52E is pushed back by the guiding surface formed as the slope 76 of the first guide member 70A with the certain force Fa. Then, the meandering fixing belt 52E entirely moves backward and returns to the original rotating position.

In this manner, the steering roller 55 exercises the function of stopping the meandering of the fixing belt 52.

Likewise, the meandering stop function of the steering roller 55 is also exercised when the fixing belt 52 meanders and is displaced backward in the direction indicated by the arrow M2 in FIG. 5A.

Each of the sides 52c and 52d of the meandering fixing belt 52E (the side 52c is shown in FIG. 5B) contacts part of the slope 76 on the guiding surface of the corresponding one of the first guide members 70A and 70B and is curved slightly upward (shown as a curved side portion 52g).

Each of the sides 52c and 52d of the meandering fixing belt 52E enters a state in which it contacts the top side of the lower curved surface 76a or part of the upper curved surface 76b of the slope 76. The curved side portion 52g of the meandering fixing belt 52E is bent by a greater amount than the curved side portion 52e of the side 52c of the fixing belt 52 when the meandering of the fixing belt 52 does not occur (see FIG. 4B).

At this time, the curved side portion 52g of the meandering fixing belt 52E is subjected to a reaction force due to the curving of the fixing belt 52 and is pressed against the guiding surface formed as the slope 76.

In this state, the oil 59 applied to the inner peripheral surface 52b of the meandering fixing belt 52E is kept being trapped between the curved side portion 52g of the meandering fixing belt 52E and the slope 76.

In the fixing device 5A, therefore, even after the meandering fixing belt 52E passes by the first guide members 70A and 70B of the steering roller 55, it is less likely that the oil 59 leaks to the outer peripheral surface 52a of the meandering fixing belt 52E.

### Second Exemplary Embodiment

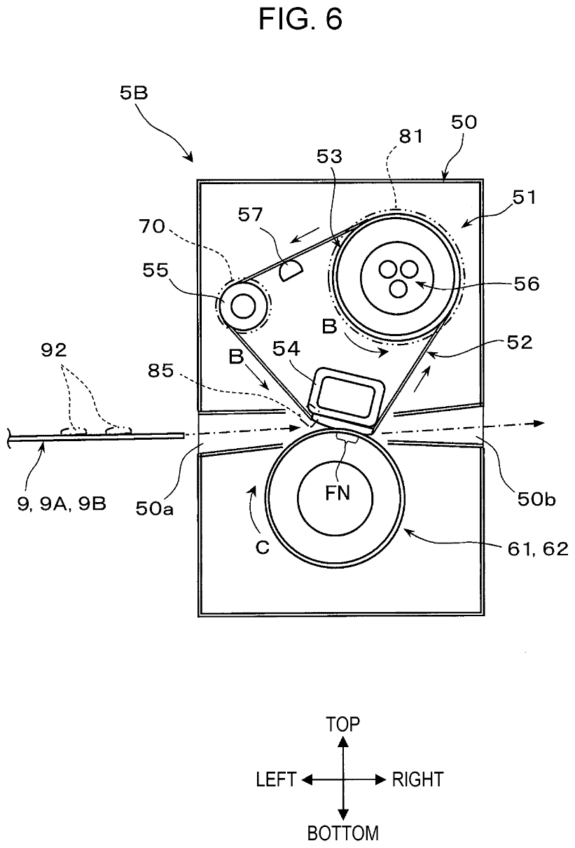

FIG. 6 is a schematic view illustrating a fixing device 5B according to a second exemplary embodiment of the disclosure.

The configuration of the fixing device 5B is the same as that of the fixing device 5A of the first exemplary embodiment, except that a second guide member 81 is provided for the heating roller 53 and a second guide member 85 is provided for the contact member 54.

### (1-1) Configuration of Second Guide Member for Heating Roller

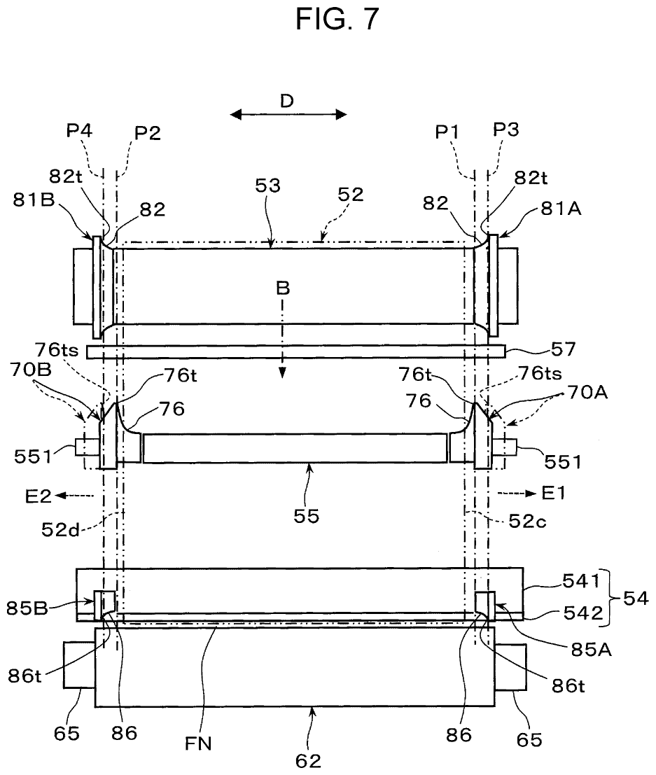

In the fixing device 5B, as illustrated in FIG. 7, second guide members 81A and 81B are attached to the vicinities of the ends of the heating roller 53.

The vicinities of the ends of the heating roller 53 are portions inward from both ends of the heating roller 53 in the axial direction by a predetermined distance. The vicinities of the ends of the heating roller 53 also correspond to portions that do not interfere with the normal rotating operation of the fixing belt 52 when the meandering of the fixing belt 52 is not occurring.

As shown in FIG. 7, the second guide members 81A and 81B have guiding surfaces 82 that the sides 52c and 52d of the fixing belt 52 may contact.

The guiding surfaces 82 of the second guide members 81A and 81B are formed as slopes tilting toward the outer side of the axial direction of the heating roller 53.

In the second exemplary embodiment, the guiding surfaces 82 are formed as slopes which are similar to the slopes 76 of the guiding surfaces of the first guide members 70A and 70B, but the width of the slopes of the guiding surfaces 82 as seen in the axial direction of the heating roller 53 is smaller than that of the slopes 76.

As shown in FIG. 7, the second guide members 81A and 81B are provided so that the guiding surfaces 82 are at least partially positioned on a farther outer side of the axial direction of the steering roller 55 than the guiding surfaces of the slopes 76 of the first guide members 70A and 70B.

The positions of the first guide members 70A and 70B in the above-described state are those when the fixing belt 52 is rotating without the occurrence of meandering.

In the second exemplary embodiment, as shown in FIG. 7, the guiding surfaces 82 of the second guide members 81A and 81B are entirely positioned on a farther outer side of the axial direction of the steering roller 55 than the guiding surfaces of the slopes 76 of the first guide members 70A and 70B.

Additionally, an outermost end 82t of each of the guiding surfaces 82 of the second guide members 81A and 81B satisfies the following positional relationship.

The outermost end 82t of each of the guiding surfaces 82 is located at the same position as the top end 76t of each of the guiding surfaces of the slopes 76 of the first guide members 70A and 70B at the time when the first guide members 70A and 70B are moved toward the outer side of the axial direction as a result of the steering roller 55 tilting at the largest angle due to the meandering fixing belt 52E.

The long dashed dotted lines P1 and P2 in FIG. 7 are virtual lines passing through the top ends 76t of the guiding surfaces of the slopes 76 of the first guide members 70A and 70B, which are located when the steering roller 55 is not tilted and the first guide members 70A and 70B are located at the normal positions.

The long dashed dotted lines P3 and P4 in FIG. 7 are virtual lines passing through outermost top ends 76ts of the guiding surfaces of the slopes 76 of the first guide members 70A and 70B, which are located when the first guide members 70A and 70B are moved toward the outer side as a result of the steering roller 55 tilting at the largest angle.

The outermost ends 82t of the guiding surfaces 82 of the second guide members 81A and 81B are also located on the long dashed dotted lines P3 and P4.

### (1-2) Configuration of Second Guide Member for Contact Member

In the fixing device 5B, as illustrated in FIG. 7, second guide members 85A and 85B are attached to the vicinities of the ends of the contact member 54.

The vicinities of the ends of the contact member 54 are portions inward from both ends of the contact member 54 in the longitudinal direction D by a predetermined distance. The vicinities of the ends of the contact member 54 also correspond to portions that do not interfere with the normal rotating operation of the fixing belt 52 when the meandering of the fixing belt 52 is not occurring.

As is seen from a combination of FIGS. 6 and 7, the second guide members 85A and 85B are disposed farther upstream in the rotation direction B of the fixing belt 52 than the fixing processing portion FN. Each of the second guide members 85A and 85B is attached to part of the supporters 541 of the contact member 54.

As shown in FIG. 7, the second guide members 85A and 85B have guiding surfaces 86 that the sides 52c and 52d of the fixing belt 52 may contact.

The guiding surfaces 86 of the second guide members 85A and 85B are formed as slopes tilting toward the outer side of the longitudinal direction D of the contact member 54.

In the second exemplary embodiment, the guiding surfaces 86 are formed as slopes which are similar to the slopes 76 of the guiding surfaces of the first guide members 70A and 70B, but the width of the slopes of the guiding surfaces 86 as seen in the longitudinal direction D of the contact member 54 is smaller than that of the slopes 76.

As shown in FIG. 7, the second guide members 85A and 85B are provided so that the guiding surfaces 86 are at least partially positioned on a farther outer side of the axial direction of the steering roller 55 than the guiding surfaces of the slopes 76 of the first guide members 70A and 70B.

In the second exemplary embodiment, as shown in FIG. 7, the guiding surfaces 86 of the second guide members 85A and 85B are entirely positioned on a farther outer side of the axial direction of the steering roller 55 than the guiding surfaces of the slopes 76 of the first guide members 70A and 70B.

Additionally, an outermost end 86t of each of the guiding surfaces 86 of the second guide members 85A and 85B satisfies the following positional relationship.

The outermost end 86t of each of the guiding surfaces 86 is located at the same position as the top end 76t of each of the guiding surfaces of the slopes 76 of the first guide members 70A and 70B at the time when the first guide members 70A and 70B are moved toward the outer side of the axial direction as a result of the steering roller 55 tilting at the largest angle due to the meandering fixing belt 52E.

That is, as in the outermost ends 82t of the guiding surfaces 82 of the second guide members 81A and 81B, the outermost ends 86t of the guiding surfaces 86 of the second guide members 85A and 85B are located on the long dashed dotted lines P3 and P4, which are the above-described virtual lines.

The state in which the steering roller 55 is tilted at the largest angle corresponds to a state in which the bearings 553 (see FIG. 3A) of the steering roller 55 are moved in the downmost position as a result of the meandering fixing belt 52E contacting the guiding surfaces of the first guide members 70A and 70B.

(2) Operation of Fixing Device Provided with First and Second Guide Members

The fixing device 5B holds the fixing belt 52 in the following manner under the normal conditions without the occurrence of meandering of the fixing belt 52.

The steering roller 55 provided with the first guide members 70A and 70B holds the fixing belt 52 similarly to that of the fixing device 5A of the first exemplary embodiment.

More specifically, as illustrated in FIG. 7, under the normal conditions, the steering roller 55 holds the fixing belt 52 so that the sides 52c and 52d of the fixing belt 52 contact the lower curved surfaces 76a (see FIG. 3B) of the slopes 76 on the guiding surfaces of the first guide members 70A and 70B.

As illustrated in FIG. 7, the heating roller 53 provided with the second guide members 81A and 81B hold the fixing belt 52 so that the sides 52c and 52d of the fixing belt 52 do not contact the guiding surfaces 82 of the second guide members 81A and 81B.

As illustrated in FIG. 7, the contact member 54 provided with the second guide members 85A and 85B hold the fixing belt 52 so that the sides 52c and 52d of the fixing belt 52 do not contact the guiding surfaces 86 of the second guide members 85A and 85B.

Under the normal conditions, in the fixing device 5B, portions of the fixing belt 52 including the sides 52c and 52d are substantially in the same state as those in the fixing device 5A of the first exemplary embodiment.

That is, the portions of the fixing belt 52 including the sides 52c and 52d each contact part of the lower curved surface 76a of the slope 76 on the corresponding guiding surface of the first guide member 70A or 70B and is curved slightly upward (shown as the curved side portion 52c) (see FIG. 4B).

At this time, the curved side portion 52e of the fixing belt 52 is subjected to a reaction force due to the curving of the fixing belt 52 and is pressed against the slope 76 on the guiding surface.

In this state, the oil 59 applied to the inner peripheral surface 52b of the fixing belt 52 is kept being trapped between the curved side portion 52e of the fixing belt 52 and the slope 76, for example (see FIG. 4B).

In the fixing device 5B, therefore, as well as in the fixing device 5A, even after the fixing belt 52 passes by the first guide members 70A and 70B of the steering roller 55, it is less likely that the oil 59 leaks to the outer peripheral surface 52a of the fixing belt 52 than in a configuration in which the guiding surface is formed as a vertical surface along the thickness direction tb of the fixing belt 52, as in the guiding surface 73 of the first guide member 70X of the comparative example (see FIG. 12).

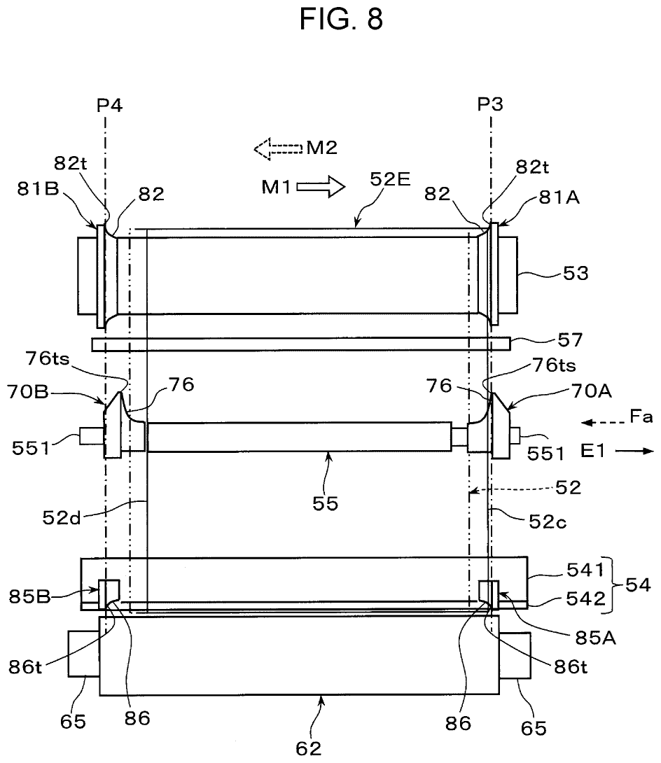

When the fixing belt 52 meanders and is displaced frontward in the direction indicated by the arrow M1, as shown in FIG. 8, the fixing device 5B holds the fixing belt 52 in the following manner.

First, the steering roller 55 provided with the first guide members 70A and 70B tilts and is then returned to the original position, similarly to the fixing device 5A of the first exemplary embodiment.

In response to the movement of the steering roller 55, as shown in FIG. 8, when the side 52c of the meandering fixing belt 52E displaced frontward is passing by the steering roller 55, the meandering fixing belt 52E is pushed back by the guiding surface of the slope 76 of the first guide member 70A with the certain force Fa. Then, the entirety of the meandering fixing belt 52E is moved backward and returns to the original rotating position.

In this manner, the steering roller 55 exercises the function of stopping the meandering of the fixing belt 52.

In the fixing device 5B, as well as in the fixing device 5A of the first exemplary embodiment, even after the meandering fixing belt 52E passes by the first guide members 70A and 70B of the steering roller 55, it is less likely that the oil 59 leaks to the outer peripheral surface 52a of the fixing belt 52.

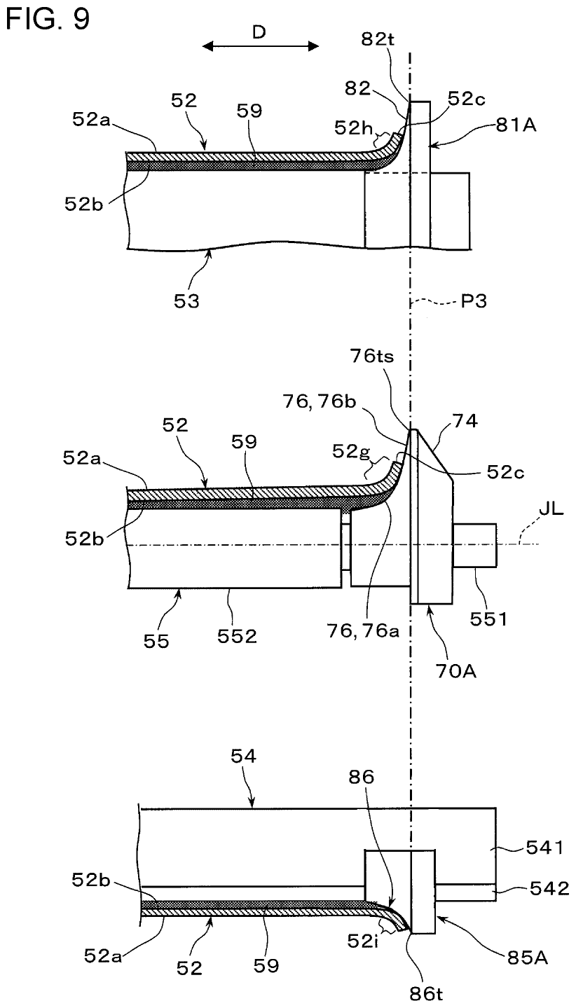

More specifically, as illustrated in FIG. 9, the side 52c of the meandering fixing belt 52E contacts part of the slope 76 on the guiding surface of the first guide member 70A and is curved slightly upward (shown as a curved side portion 52g).

The curved side portion 52g of the meandering fixing belt 52E is subjected to a reaction force due to the curving of the fixing belt 52 and is pressed against the slope 76 on the guiding surface.

In this state, the oil 59 applied to the inner peripheral surface 52b of the meandering fixing belt 52E is kept being trapped between the curved side portion 52g of the meandering fixing belt 52E and the slope 76.

In the fixing device 5B, therefore, as well as in the fixing device 5A, it is less likely that the oil 59 leaks to the outer peripheral surface 52a of the meandering fixing belt 52E.

In the fixing device 5B, as shown in FIG. 8, the meandering fixing belt 52E also contacts and passes by the guiding surface 82 of the second guide member 81A disposed at the front side of the heating roller 53 and the guiding surface 86 of the second guide member 85A disposed at the front side of the contact member 54.

At this time, as illustrated in FIG. 9, a portion including the side 52c of the meandering fixing belt 52E contacts part of the guiding surface 82 (slope) of the second guide member 81A attached to the heating roller 53 and is curved slightly upward (shown as a curved side portion 52h).

Also at this time, as illustrated in FIG. 9, a portion including the side 52c of the meandering fixing belt 52E contacts part of the guiding surface 86 (slope) of the second guide member 85A attached to the contact member 54 and is curved slightly upward (shown as a curved side portion 52i).

The curved side portions 52h and 52i including the side 52c are curved almost in the same manner if the slope of the guiding surface 82 and that of the guiding surface 86 are formed identically.

The curved side portion 52h of the meandering fixing belt 52E is subjected to a reaction force due to the curving of the fixing belt 52 and is pressed against the slope on the guiding surface 82 of the second guide member 81A. The curved side portion 52i of the meandering fixing belt 52E is also subjected to a reaction force due to the curving of the fixing belt 52 and is pressed against the slope on the guiding surface 86 of the second guide member 85A.

In this state, when the meandering fixing belt 52E is passing by the second guide member 81A, the oil 59 applied to the inner peripheral surface 52b of the meandering fixing belt 52E is kept being trapped between the curved side portion 52h of the meandering fixing belt 52E and the slope on the guiding surface 82.

Also in this state, when the meandering fixing belt 52E is passing by the second guide member 85A, the oil 59 applied to the inner peripheral surface 52b of the meandering fixing belt 52E is kept being trapped between the curved side portion 52i of the meandering fixing belt 52E and the slope on the guiding surface 86.

In the fixing device 5B, as well as in the fixing device 5A, it is thus less likely that the oil 59 applied to the inner peripheral surface 52b of the meandering fixing belt 52E leaks to the outer peripheral surface 52a even after the meandering fixing belt 52E passes by the first guide members 70A and 70B and also passes by the second guide members 81A, 81B, 85A, and 85B.

Additionally, in the second guide members 81A, 81B, 85A, and 85B of the fixing device 5B, as shown in FIG. 7, the guiding surfaces 82 and 86 are at least partially positioned on a farther outer side of the axial direction of the steering roller 55 than the guiding surfaces of the first guide members 70A and 70B.

With this configuration, it is possible to avoid the meandering fixing belt 52E from contacting the guiding surfaces 82 and 86 of the second guide members 81A, 81B, 85A, and 85B earlier than the guiding surfaces of the first guide members 70A and 70B. Hence, the first guide members 70A and 70B can smoothly move toward the outer side of the axial direction of the steering roller 55 after the meandering fixing belt 52E contacts the first guide members 70A and 70B, unlike the configuration in which the second guide members 81A, 81B, 85A, and 85B are located at the same position as the first guide members 70A and 70B along the axial direction of the steering roller 55.

As a result, the function of the steering roller 55 to correct the meandering of the fixing belt 52 is not impaired. It is also less likely that the oil 59 leaks to the outer peripheral surface 52a of the meandering fixing belt 52E even after the meandering fixing belt 52E passes by the guiding surfaces of the first guide members 70A and 70B and the guiding surfaces 82 of the second guide members 81A and 81B and the guiding surfaces 86 of the second guide members 85A, and 85B.

Additionally, as shown in FIGS. 7 and 8, the outermost ends 82t and 86t of the guiding surfaces 82 and 86 of the second guide members 81A, 81B, 85A, and 85B are located at the same position as the outermost top ends 76ts of the guiding surfaces of the first guide members 70A and 70B at the time when the first guide members 70A and 70B are moved toward the outer side in response to the steering roller 55 tilting at the largest angle.

In the fixing device 5B, it may be possible that the steering roller 55 tilts at the largest angle when the fixing belt 52E meandering frontward contacts the guiding surface (slope) of the first guide member 70A and is moved toward the outer side of the axial direction.

Even in this case, compared with the configuration in which the outermost ends 82t and 86t of the guiding surfaces 82 and 86 are located on a farther outer side of the axial direction than the outermost top ends 76ts of the guiding surfaces of the first guide members 70A and 70B at the time when the first guide members 70A and 70B are moved toward the outer side in response to the steering roller 55 tilting at the largest angle, a load is less imposed as described below.

As illustrated in FIGS. 8 and 9, before the steering roller 55 tilts at the largest angle, the side 52c of the meandering fixing belt 52E contacts the guiding surface 82 of the second guide member 81A and the guiding surface 86 of the second guide member 85A as well as the guiding surface of the first guide member 70A.

With this configuration, even if the steering roller 55 tilts at the largest angle or almost at the largest angle, a load imposed by the side 52c of the meandering fixing belt 52E contacting the guiding surface of the slope 76 of the first guide member 70A of the steering roller 55 is cased.

Additionally, even if the steering roller 55 tilts at the largest angle, compared with the configuration in which the outermost ends 82t and 86t of the guiding surfaces 82 and 86 are located farther inward along the axial direction than the outermost top ends 76ts of the guiding surfaces of the first guide members 70A and 70B at the time when the first guide members 70A and 70B are moved toward the outer side in response to the steering roller 55 tilting at the largest angle, a load is less imposed as described below.

If the outermost ends 82t and 86t of the guiding surfaces 82 and 86 are located farther inward, when the steering roller 55 tilts at the largest angle, the side 52c of the meandering fixing belt 52E may be pressed hard against the guiding surface 82 of the second guide member 81A and the guiding surface 86 of the second guide member 85A earlier than the guiding surface of the first guide member 70A. In the fixing device 5B, however, such a situation does not occur.

In the fixing device 5B, therefore, it is possible to make it less likely to increase the load, which is caused by the side 52c of the meandering fixing belt 52E contacting the guiding surface 82 of the second guide member 81A provided for the heating roller 53 and the guiding surface 86 of the second guide member 85A provided for the contact member 54.

### Modified Examples

The disclosure is not limited to the configurations of the first and second exemplary embodiments. Necessary changes and modifications, such as combining of elements, may be made without departing from the spirit and scope of the disclosure. The disclosure encompasses the following modified examples, for instance.

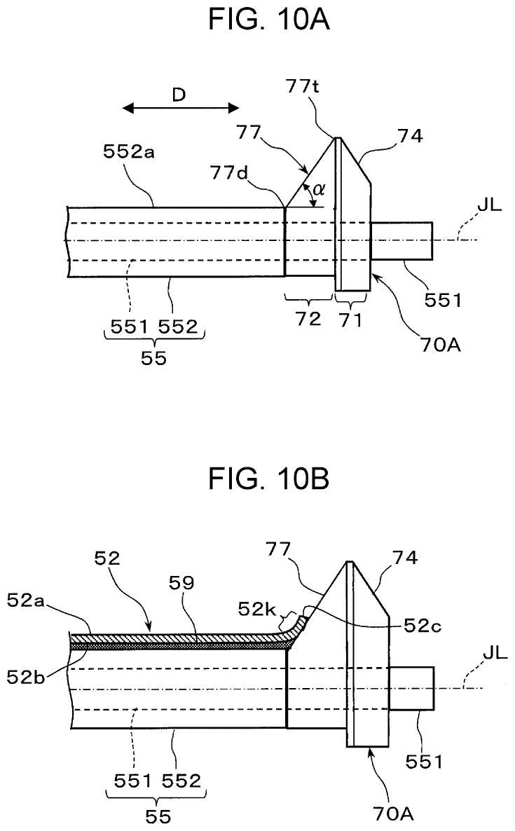

Each of the guiding surfaces of the first guide members 70A and 70B may be formed as a slope 77 tilting straight, as shown in FIGS. 10A and 10B. The slope 77 of the guide member 70A is shown in FIGS. 10A and 10B.

The slope 77 extends straight from a bottom end 77d to a top end 77t. The tilt angle a of the slope 77 with respect to the axis JL of the steering roller 55 may be set to 30° to 75°, for example.

If the tilt angle a is smaller than 30°, some inconveniences may occur, such as the occurrence of a leakage of the oil 59 to the outer peripheral surface 52a of the fixing belt 52. Conversely, if the tilt angle a is larger than 75°, some inconveniences may occur, such as the occurrence of cracks in the fixing belt 52 as a result of the fixing belt 52 climbing along the slope 77 and the fracture strain of a side of the fixing belt 52 exceeding a threshold.

The bottom end 77d of the slope 77 is the innermost end of the slope 77 in the axial direction. The top end 77t of the slope 77 is the outermost end of the slope 77 in the axial direction. The position of the bottom end 77d of the slope 77 is the position at which the distance of the steering roller 55 from the center of the rotating shaft 551 in the radial direction is equal to the distance of the steering roller 55 from the center of the roller body 552 to the surface 552a of the roller body 552 in the radial direction.

The steering roller 55 provided with the first guide member 70A (70B) having a guiding surface formed as the slope 77 holds the fixing belt 52 in the following manner under the normal conditions without the occurrence of meandering of the fixing belt 52.

As illustrated in FIG. 10B, the steering roller 55 holds the fixing belt 52 so that the side 52c of the fixing belt 52 contacts part of the slope 77 on the guiding surface of the first guide member 70A.

In this case, as illustrated in FIG. 10B, a portion of the fixing belt 52 including the side 52c contacts part of the slope 77 on the guiding surface of the first guide member 70A and is curved slightly upward (shown as a curved side portion 52k).

At this time, the curved side portion 52k of the fixing belt 52 is subjected to a reaction force due to the curving of the fixing belt 52 and is pressed against the slope 77 on the guiding surface.

In this state, the oil 59 applied to the inner peripheral surface 52b of the fixing belt 52 is kept being trapped between the curved side portion 52k of the fixing belt 52 and the slope 77, for example.

Hence, in a fixing device including the first guide members 70A and 70B each having a guiding surface formed as the slope 77, it is less likely that the oil 59 leaks to the outer peripheral surface 52a of the fixing belt 52, as in the fixing device 5A of the first exemplary embodiment and the fixing device 5B of the second exemplary embodiment.

The guiding surface of the first guide member 70 may be formed as a curved slope having only one curvature value. The guiding surface of the first guide member 70 may be a slope having a combination of a curved slope portion and a straight slope portion.

Only one of the second guide member 81 for the heating roller 53 and the second guide member 85 for the contact member 54 may be provided. That is, the second guide member may be provided only for one of the heating roller 53 and the contact member 54.

The guiding surfaces 82 and 86 of the second guide members 81 and 85 may be formed as slopes configured differently from the slope of the guiding surface of the first guide member 70. At least one of the guiding surfaces 82 and 86 of the second guide members 81 and 85 may be formed as a vertical surface, such as the guiding surface 73 of the first guide member 70X of the comparative example.

As long as the fixing device of an embodiment of the disclosure applies the oil 59 to the inner peripheral surface 52b of the fixing belt 52 and includes the steering roller 55, the type and heating method of the heater 56 and the types and the number of holding members for holding the fixing belt 52, other than the steering roller 55, may be changed.

The installation position of the oil application device 57 and the number of oil application devices may be changed.

In the above-described exemplary embodiments, such as the first exemplary embodiment, as the image forming apparatus 10, an image forming apparatus that forms a single-color image is used. However, the image forming apparatus of an embodiment of the disclosure may be an apparatus that forms a multicolor image constituted by multiple colors of toners. Various methods, such as the image forming method and the transfer method, utilized in the image forming apparatus of an embodiment of the disclosure are not limited to particular methods as long as a fixing device of an embodiment of the disclosure is applied to the image forming apparatus.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### Appendix

(((1)))

A fixing device comprising:
a fixing belt;
a plurality of holding members that hold the fixing belt so that the fixing belt is rotatable;
a pressing roller that presses the fixing belt against one of the plurality of holding members from an outer peripheral surface of the fixing belt so as to form a fixing processing portion;
an applicator that applies oil to an inner peripheral surface of the fixing belt; and
a first guide member that is provided for at least one holding member of the plurality of holding members and includes a guiding surface with which a side of the fixing belt is brought into contact, the guiding surface being formed as a slope tilting toward an outer side of a longitudinal direction of the at least one holding member.
   (((2)))

The fixing device according to (((1))), wherein the slope of the guiding surface is a slope tilting in a curved shape projecting toward the outer side.

(((3)))

The fixing device according to (((1))), wherein the slope of the guiding surface is a slope tilting straight.

(((4)))

The fixing device according to one of (((1))) to (((3))), wherein:
the at least one holding member is a steering roller that corrects meandering of the fixing belt as a result of the steering roller being tilted in response to the meandering of the fixing belt and then returning to an original position; and
the first guide member is provided to be movable in an axial direction of a rotating shaft of the steering roller.
   (((5)))

The fixing device according to (((4))), wherein:
another one of the plurality of holding members is a rotator roller including a heater; and
a second guide member is attached to the rotator roller, the second guide member including a guiding surface with which a side of the fixing belt is brought into contact, at least part of the guiding surface being positioned on a farther outer side of the axial direction of the steering roller than the guiding surface of the first guide member.
   (((6)))

The fixing device according to (((5))), wherein an outermost end of the guiding surface of the second guide member is located at a position identical to a position of an outermost end of the guiding surface of the first guide member at a time when the first guide member is moved toward the outer side of the axial direction of the steering roller as a result of the steering roller tilting at a largest angle.

(((7)))

The fixing device according to (((6))), wherein the guiding surface of the second guide member is formed as a slope tilting toward an outer side of an axial direction of the rotator roller.

(((8)))

The fixing device according to (((4))), wherein a second guide member is attached to each of the plurality of holding members other than the steering roller, the second guide member including a guiding surface with which a side of the fixing belt is brought into contact, at least part of the guiding surface being positioned on a farther outer side of an axial direction of the steering roller than the guiding surface of the first guide member.

(((9)))

The fixing device according to (((8))), wherein an outermost end of the guiding surface of the second guide member is located at a position identical to a position of an outermost end of the guiding surface of the first guide member at a time when the first guide member is moved toward an outer side as a result of the steering roller tilting at a largest angle.

(((10)))

The fixing device according to (((9))), wherein the guiding surface of the second guide member is formed as a slope tilting toward an outer side of a longitudinal direction of each of the plurality of holding members other than the steering roller.

(((11)))

An image forming apparatus comprising:
the fixing device according to one of (((1))) to (((10))).

What is claimed is:

1. A fixing device comprising:
a fixing belt;
a plurality of holding members that hold the fixing belt so that the fixing belt is rotatable;
a pressing roller that presses the fixing belt against one of the plurality of holding members from an outer peripheral surface of the fixing belt so as to form a fixing processing portion;
an applicator that applies oil to an inner peripheral surface of the fixing belt; and
a first guide member that is provided for at least one holding member of the plurality of holding members and includes a guiding surface with which a side of the fixing belt is brought into contact, the guiding surface being formed as a slope tilting toward an outer side of a longitudinal direction of the at least one holding member.

2. The fixing device according to claim 1, wherein the slope of the guiding surface is a slope tilting in a curved shape projecting toward the outer side.

3. The fixing device according to claim 1, wherein the slope of the guiding surface is a slope tilting straight.

4. The fixing device according to claim 1, wherein:
the at least one holding member is a steering roller that corrects meandering of the fixing belt as a result of the steering roller being tilted in response to the meandering of the fixing belt and then returning to an original position; and
the first guide member is provided to be movable in an axial direction of a rotating shaft of the steering roller.

5. The fixing device according to claim 4, wherein:
another one of the plurality of holding members is a rotator roller including a heater; and
a second guide member is attached to the rotator roller, the second guide member including a guiding surface with which a side of the fixing belt is brought into contact, at least part of the guiding surface being positioned on a farther outer side of the axial direction of the steering roller than the guiding surface of the first guide member.

6. The fixing device according to claim 5, wherein an outermost end of the guiding surface of the second guide member is located at a position identical to a position of an outermost end of the guiding surface of the first guide member at a time when the first guide member is moved toward the outer side of the axial direction of the steering roller as a result of the steering roller tilting at a largest angle.

7. The fixing device according to claim 6, wherein the guiding surface of the second guide member is formed as a slope tilting toward an outer side of an axial direction of the rotator roller.

8. The fixing device according to claim 4, wherein a second guide member is attached to each of the plurality of holding members other than the steering roller, the second guide member including a guiding surface with which a side of the fixing belt is brought into contact, at least part of the guiding surface being positioned on a farther outer side of an axial direction of the steering roller than the guiding surface of the first guide member.

9. The fixing device according to claim 8, wherein an outermost end of the guiding surface of the second guide member is located at a position identical to a position of an outermost end of the guiding surface of the first guide member at a time when the first guide member is moved toward an outer side as a result of the steering roller tilting at a largest angle.

10. The fixing device according to claim 9, wherein the guiding surface of the second guide member is formed as a slope tilting toward an outer side of a longitudinal direction of each of the plurality of holding members other than the steering roller.

11. An image forming apparatus comprising:
the fixing device according to claim 1.

12. An image forming apparatus comprising:
the fixing device according to claim 2.

13. An image forming apparatus comprising:
the fixing device according to claim 3.

14. An image forming apparatus comprising:
the fixing device according to claim 4.

15. An image forming apparatus comprising:
the fixing device according to claim 5.

16. An image forming apparatus comprising:
the fixing device according to claim 6.

17. An image forming apparatus comprising:
the fixing device according to claim 7.

18. An image forming apparatus comprising:
the fixing device according to claim 8.

19. An image forming apparatus comprising:
the fixing device according to claim 9.

20. An image forming apparatus comprising:
the fixing device according to claim 10.
